(19) United States
(12) Patent Application Publication
(10) Pub. No.: US 2019/0016196 A1
(43) Pub. Date: Jan. 17, 2019

(54) Anti-Seepage Vehicle-Mounted Humidifier

(71) Applicant: Shenzhen Huiqimei Technology Co., Ltd., Shenzhen (CN)

(72) Inventor: Jianling YE, Shenzhen (CN)

(73) Assignee: Shenzhen Huiqimei Technology Co., Ltd.

(21) Appl. No.: 15/873,837

(22) Filed: Jan. 17, 2018

(30) Foreign Application Priority Data
Jul. 12, 2017 (CN) 201710563930.1

(51) Int. Cl. B60H 3/02; B60H 1/32

(52) U.S. Cl. CPC B60H 3/022; B60H 1/3202

(57) ABSTRACT

The invention relates to the technical field of humidifiers, and provides an anti-seepage vehicle-mounted humidifier which comprises a humidifier main body and a vehicle charger body, wherein the humidifier main body comprises an atomizer and a water tank; the atomizer comprises a valve body, a pipe body, an atomization assembly and a controller. According to the invention, when the atomization assembly is started by the controller to enter into humidification mode, water interruption and water shortages can be avoided; when the water inlet rotates along with the pipe body to deviate from the communication port, the water tank is isolated from the pipe body and the atomizer, and thus water seepage is avoided.

### BACKGROUND OF THE INVENTION

### Technical Field

The invention relates to a humidifier, in particular to an anti-seepage vehicle-mounted humidifier.

### Description of Related Art

At present, water tanks of traditional vehicle-mounted humidifiers are arranged below atomizers, and the water in the water tanks is absorbed into the atomizers through water-absorption cotton swabs and then atomized. As the water-absorption cotton swabs absorb water by means of the hydroscopicity of cotton, water supply in the atomization process is instable, and the water supply speed and the water supply quantity are limited. To solve the problem, certain vehicle-mounted humidifiers with water tanks above atomizers are provided, however, since a plurality of tiny holes are formed in atomization pieces of the atomizers, after the atomization pieces stop operating, residual water in the water tanks can seep from the tiny holes in the atomization pieces under the effect of the water pressure, and consequentially water seepage of the humidifiers is caused.

### BRIEF SUMMARY OF THE INVENTION

To solve the problem that the vehicle-mounted humidifiers in the prior art are prone to water seepage, the invention aims to provide an anti-seepage vehicle-mounted humidifier.

According to the technical scheme adopted by the invention for solving the above technical problem: an anti-seepage vehicle-mounted humidifier is provided and comprises a humidifier main body and a vehicle charger body, wherein the vehicle charger body is connected with the humidifier main body and can be connected with the vehicle body to achieve electrical connection between the humidifier main body and the vehicle body, and the humidifier main body comprises an atomizer and a water tank arranged above the atomizer; the atomizer comprises a valve body, a pipe body, an atomization assembly and a controller, wherein the pipe body stretches into the valve body and can rotate in the valve body, the atomization assembly is arranged at the end of the pipe body and can rotate along with the pipe body, and the controller is used for controlling the atomization assembly; the valve body is provided with a communication port communicated with the water tank, and the pipe body is provided with a water inlet; when the water inlet rotates to the communication port along with the pipe body, the pipe body is communicated with the water tank, and the atomization assembly is started by the controller to enter into humidification mode; when the water inlet rotates along with the pipe body to deviate from the communication port, the pipe body is isolated from the water tank, and the atomization assembly is controlled by the controller to stop humidifying.

Optionally, the atomizer further comprises a shell, and the valve body and the pipe body are arranged in the shell; a mounting hole is formed in the side wall of the shell, the atomization assembly is arranged outside the mounting hole, and the water tank is arranged at the top of the shell.

Optionally, the top edge of the valve body extends outwards to form a round flange, and a first clamping groove allowing the round flange to be clamped therein is formed in the shell.

Optionally, the valve body comprises an upper cylindrical pipe which is arranged longitudinally and a lower cylindrical pipe which is arranged transversely and communicated with the upper cylindrical pipe, a connecting pipe which can stretch into the upper cylindrical pipe and is connected with the upper cylindrical pipe in a threaded mode is arranged at the bottom of the water tank, and the pipe body is arranged in the lower cylindrical pipe.

Optionally, the atomization assembly comprises an atomization piece and an atomization piece cover; a cavity is formed in the end of the pipe body, and the atomization piece is arranged in the cavity; a second clamping groove is formed in the end of the pipe body, the atomization piece cover is located outside the atomization piece, and a clamping block which can be clamped in the second clamping groove is arranged on the atomization piece.

Optionally, the controller comprises a mainboard and an atomization switch arranged on the mainboard; the pipe body comprises a first pipe body part and a second pipe body part, the first pipe body part stretches into the valve body, the water inlet is located in the first water pipe body part, and a switch trigger which can trigger the atomization switch is arranged on the second pipe body part.

Optionally, the anti-seepage vehicle-mounted humidifier further comprises a silicone sheath, wherein the silicone sheath comprises a sleeve located at the top, a connector located at the bottom and a connection part through which the sleeve and the connector are communicated, the atomizer is arranged in the sleeve, and the connector is fixed to the top of the vehicle charger body.

Optionally, an S-shaped pipe is arranged in the connection part in a penetrating mode, a wire electrically connected with the controller and the vehicle charger body is arranged in the S-shaped pipe, and the top end of the S-shaped pipe is fixed in the shell through a fixing component; the fixing component comprises a sleeve pipe and a positioning block arranged outside the sleeve pipe in a sleeving mode, and a third clamping groove allowing the positioning block to be clamped therein to be positioned is formed in the shell.

Optionally, a fourth clamping groove is formed in the top of the vehicle charger body, and the bottom edge of the connector is clamped in the fourth clamping groove; positioning columns downwards stretch out from the bottom of the connector, and positioning holes allowing the positioning columns to stretch therein to be fixed are formed in the top of the vehicle charger body.

Optionally, the vehicle charger body comprises a vehicle charger body main shell, a vehicle charger circuit board, a contact piece and an upper cover, wherein the vehicle charger body main shell is provided with an accommodating cavity, the vehicle charger circuit board arranged in the vehicle charger body main shell, the contact piece is electrically connected with the vehicle charger circuit board, partially stretches out of the vehicle charger body main shell and is connected with a vehicle-mounted circuit, and the upper cover is arranged on the vehicle charger body main shell in a covering mode.

According to the anti-seepage vehicle-mounted humidifier in the invention, when the water inlet rotates to the communication port along with the pipe body, the pipe body is communicated with the water tank, the atomization assembly is started by the controller to enter into humidification mode, and as the water tank is arranged above the atomizer, the atomizer can operate more stably under the effect of the water pressure in the water tank, and water interruption and water shortages are avoided; when the water inlet rotates along with the pipe body to deviate from the communication port, the pipe body is isolated from the water tank, the atomization assembly is controlled by the controller to stop humidifying, and at the moment, the water tank is isolated from the pipe body and the atomizer, so that residual water in the water tank is prevented from entering the atomizer, water seepage is avoided accordingly, and the problem of water seepage of existing humidifiers is solved.

### BRIEF DESCRIPTION OF THE SEVERAL VIEWS OF THE DRAWINGS

FIG. 1 is a space diagram of an anti-seepage vehicle-mounted humidifier in an embodiment of the invention;

FIG. 2 is an exploded diagram of the anti-seepage vehicle-mounted humidifier in the embodiment of the invention;

FIG. 3 is a partial sectional view of the anti-seepage vehicle-mounted humidifier in the embodiment of the invention;

FIG. 4 is an exploded diagram of a shell in the embodiment of the invention;

FIG. 5 is a spatial structural diagram of a valve body in the embodiment of the invention;

FIG. 6 is a spatial structural diagram of an atomization piece in the embodiment of the invention;

FIG. 7 is a spatial structural diagram of a pipe body in the embodiment of the invention;

FIG. 8 is a spatial structural diagram of a fixing component in the embodiment of the invention;

FIG. 9 is a spatial structural diagram of a vehicle charger body in the embodiment of the invention; and

FIG. 10 is a spatial structural diagram of a silicone sheath with the lower end turned upwards in the embodiment of the invention.

### DETAILED DESCRIPTION OF THE INVENTION

For a clearer understanding of the purposes, technical schemes and advantages of the invention, a further detailed description of the invention is given with accompanying drawings and embodiments as follows. It should be understood that the specific embodiment in the following description is only used for explaining the invention, but is not used for limiting the invention.

What needs to be pointed out is that when an element is fixed to or arranged on another element, the element can be directly connected to another element or an element is possibly located between the element and another element. When an element is connected to another element, the element can be directly connected to another element or an element is possibly located between the element and another element.

What also needs to be pointed out is that orientation terms such as left, right, upper, lower and the like are only relative concepts or take the normal service state of the product as reference and should not be regarded as restrictive.

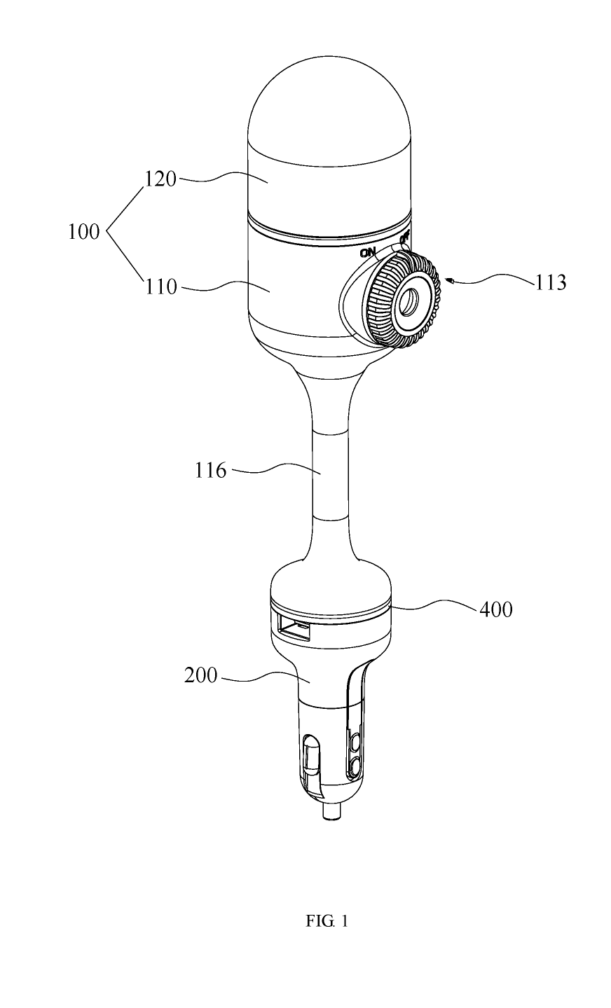

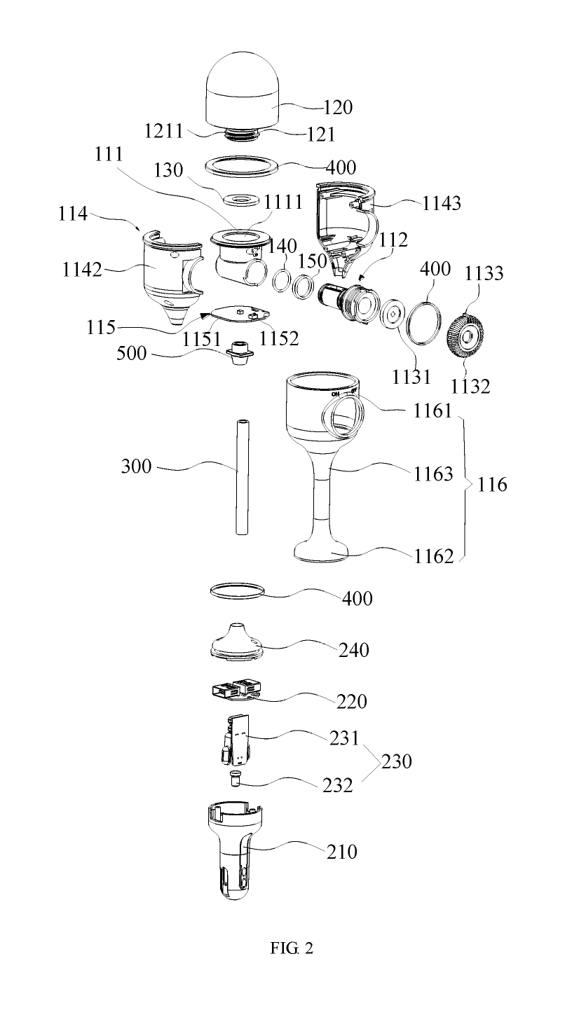

As is shown in FIG. 1 and FIG. 2, the embodiment of the invention provides an anti-seepage vehicle-mounted humidifier which comprises a humidifier main body 100 and a vehicle charger body 200 connected with the humidifier main body 100. The vehicle charger body 200 can be connected with the vehicle body, so that the humidifier main body 100 and the vehicle body are electrically connected, and accordingly the normal humidification function of the humidifier main body 100 is ensured. The humidifier main body 100 comprises an atomizer 110 and a water tank 120 arranged above the atomizer 110. The atomizer 110 comprises a valve body 111, a pipe body 112, an atomization assembly 113 and a controller 115, wherein the pipe body 112 stretches into the valve body 111 and can rotate in the valve body 111, the atomization assembly 113 is arranged at the end of the pipe body 112 and can rotate along with the pipe body 112, and the controller 115 is used for controlling the atomization assembly 113. The valve body 111 is provided with a communication port 1111 communicated with the water tank 120, and the pipe body 112 is provided with a water inlet 1121; when the water inlet 1121 rotates to the communication port 1111 along with the pipe body 112, the pipe body 112 is communicated with the water tank 120, and the atomization assembly 113 is started by the controller 115 to enter into humidification mode; when the water inlet 1121 rotates along the pipe body 112 to deviate from the communication port 1111, the pipe body 112 is isolated from the water tank 120, and the atomization assembly 113 is controlled by the controller 115 to stop humidifying.

In the embodiment of the invention, when the water inlet 1121 rotates to the communication port 1111 along with the pipe body 112, the pipe body 112 is communicated with the water tank 120, the atomization assembly 113 is started by the controller 115 to enter into humidification mode, as the water tank 120 is arranged above the atomizer 110, the atomizer 110 can operate more stably under the effect of the water pressure in the water tank 120, and water interruption and water shortages are avoided; when the water inlet 1121 rotates long with the pipe body 112 to deviate from the communication port 1111, the pipe body 112 is isolated from the water tank 120, the atomization assembly 113 is controlled by the controller 115 to stop humidifying, and at the moment, the water tank 120 is isolated from the pipe body 112 and the atomizer 110, so that residual water in the water tank 120 is prevented from entering the atomizer 110, water seepage is avoided accordingly, and the problem of water seepage of existing humidifiers is solved.

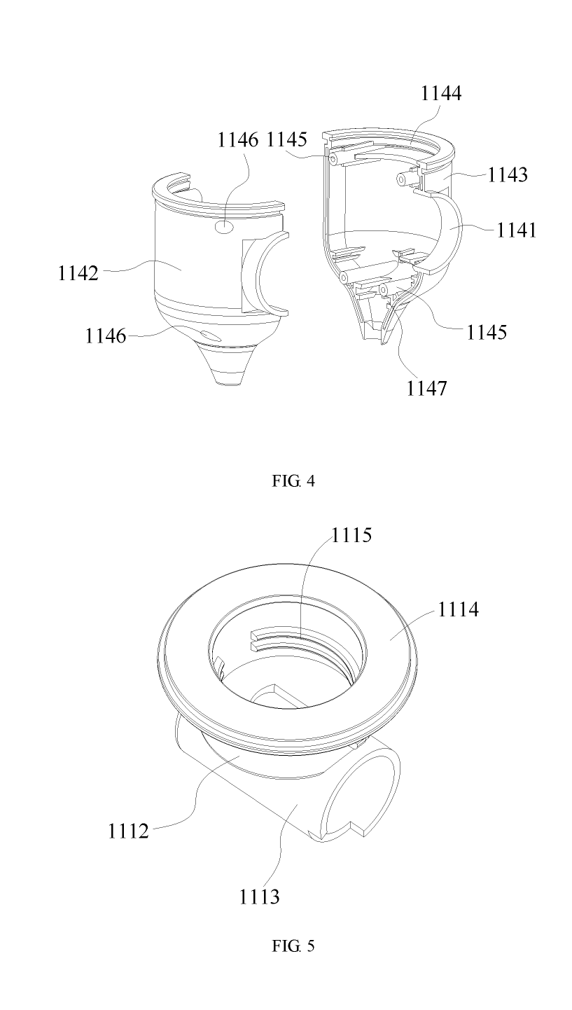

Specifically, in the embodiment, the atomizer 110 further comprises a shell 114 with an opening in the top, and the valve body 111 and the pipe body 112 are arranged in the shell 114. The valve body 111 is exposed from the opening and used for being connected with the water tank 120. Meanwhile, a mounting hole 1141 is formed in the side wall of the shell 114, the end of the pipe body 112 is located at the mounting hole 1141, the atomization assembly 113 is arranged outside the mounting hole 1141, and the water tank 120 is arranged at the top of the shell 114. As is shown in FIG. 2 and FIG. 4, the shell 114 is formed by a left shell body 1142 and a right shell body 1143 which are symmetrical and connected with each other in an abutting mode. Specifically, studs 1145 are arranged in the right shell body 1143, and screw holes 1146 corresponding to the studs 1145 are formed in the left shell body 1142, screws penetrate through the screw holes 1146 and stretch into the studs 1145 so as to be screwed, and thus the left shell body 1142 and the right shell body 1143 are connected. Of course, the screw holes 1146 and the studs 1145 can be exchanged in position, namely the screw holes 1146 are formed in the right shell body 1143, and the studs 1145 are arranged in the left shell body 1142. By adoption of the shell 114 structure, on the one hand, the semi-closed shell structure is more beneficial to mold opening and manufacturing, and on the other hand, the valve body 111 and the pipe body 112 can be mounted in the shell conveniently. Specifically, after the valve body 111 and the pipe body 112 are mounted, the assembly is placed in the left shell body 1142 or the right shell body 1143, and then the other half shell body is fixed through the screws.

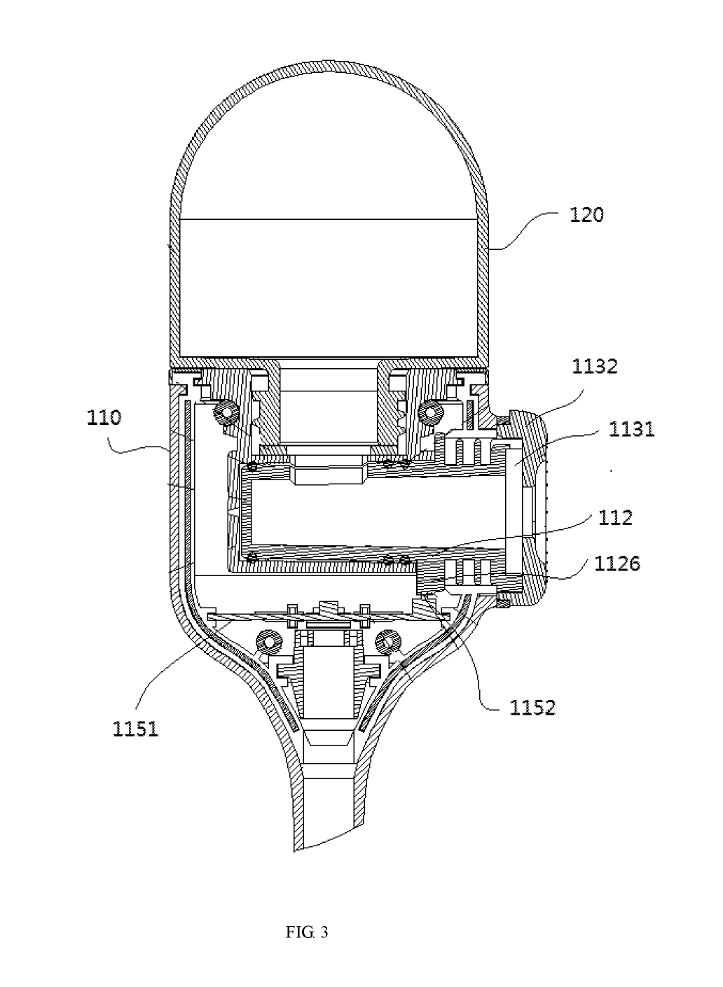

As is shown in FIG. 2, FIG. 3 and FIG. 5, the valve body 111 comprises an upper cylindrical pipe 1112 which is arranged longitudinally and a lower cylindrical pipe 1113 which is arranged transversely and communicated with the upper cylindrical pipe 1112. The top edge of the upper cylindrical pipe 1112 of the valve body 111 extends outwards to form a round flange 1114, and a first clamping groove 1144 allowing the round flange 1114 to be clamped therein is formed in the shell 114 formed by the left shell body 1142 and the right shell body 1143. Wherein, the upper cylindrical pipe 1112 is internally provided with an internal thread 1115, a connecting pipe 121 is arranged at the bottom of the water tank 120 and provided with an external thread 1211, the connecting pipe 121 stretches into the upper cylindrical pipe 1112 and is connected with the upper cylindrical pipe 1112 in a threaded mode, and thus the water tank 120 and the atomizer 110 are connected. In the embodiment, the pipe body 112 horizontally stretches into the lower cylindrical pipe 1113.

For improving the airtightness between the water tank 120 and the atomizer 110, in the embodiment, a first waterproof ring 130 is arranged between the connecting pipe 121 and the pipe body. Meanwhile, a second waterproof ring 140 and a third waterproof ring 150 are arranged on the pipe body 112 in a sleeving mode and separately located on the two sides of the water inlet 1121.

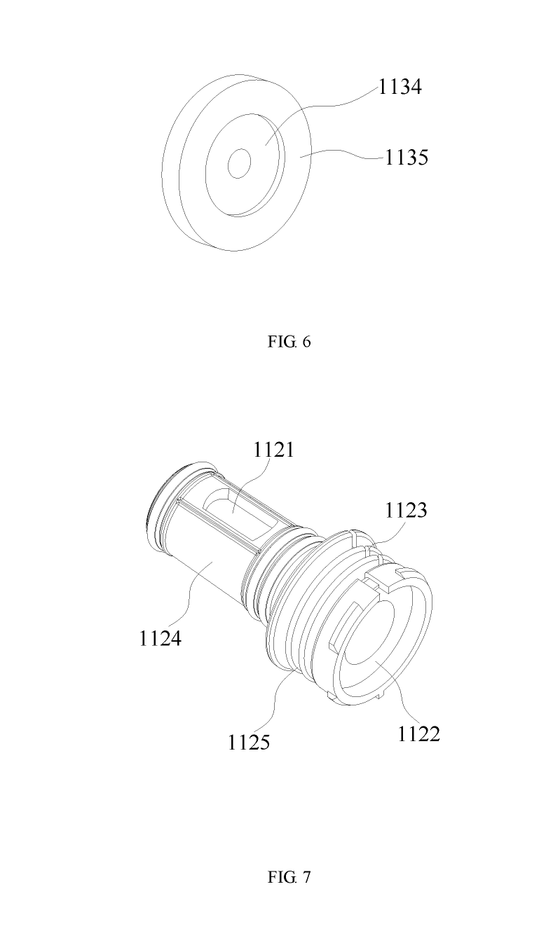

As is shown in FIG. 2, the atomization assembly 113 comprises an atomization piece 1131 and an atomization piece cover 1132. As is shown in FIG. 6, the atomization piece 1131 comprises an annular mist sprayer 1134 and a waterproof rubber ring 1135 arranged on the periphery of the mist sprayer in a sleeving mode. The atomization piece cover 1132 is also of an annular piece structure, and a plurality of atomization ports are distributed on the atomization piece cover 1132 in the circumferential direction. As is shown in FIG. 3, a cavity 1122 is formed in the end of the pipe body 112, the atomization piece 1131 is arranged in the cavity 1122, and the atomization piece cover 1132 is arranged outside the atomization piece 1131 in a covering mode. A second clamping groove 1123 is formed in the end of the pipe body 112, and a clamping block 1133 which can be clamped in the second clamping groove 1123 is arranged on the atomization piece cover 1132; when the clamping block 1133 is clamped in the second clamping groove 1123, the atomization piece cover 1132 is mounted, meanwhile, the atomization piece cover 1132 and the pipe body 112 can rotate together to form a whole, and the pipe body 112 can be driven to rotate when the atomization piece cover 1132 is rotated.

As is shown in FIG. 2, FIG. 3 and FIG. 7, in the embodiment, the controller 115 is arranged in the shell 114 of the atomizer 110 and comprises a mainboard 1151 and an atomization switch 1152 arranged on the mainboard 1151. The pipe body 112 comprises a first pipe body part 1124 and a second pipe body part 1125, wherein the first pipe body part 1124 stretches into the lower cylindrical pipe 1113 of the valve body 111, the water inlet 1121 is located in the first pipe body part 1124, the second pipe body part 1125 is located in the shell 114 and stretches out of the valve body 111, and a switch trigger 1126 which can trigger the atomization switch 1152 is arranged on the second pipe body part 1125. The positional relation of the water inlet 1121, the atomization switch 1152 and the switch trigger 1126: when the switch trigger 1126 rotates to the atomization switch 1152, the water inlet 1121 is right located at the communication port 1111 of the valve body 111, and the water tank 120 is communicated with the pipe body 112 at the moment.

As is shown in FIG. 2, the atomizer 110 further comprises a silicone sheath 116. The silicone sheath 116 comprises a sleeve 1161 located at the top, a connector 1162 located at the bottom, and a hollow connection part 1163 through which the sleeve 1161 and the connector 1162 are communicated. The structure of the sleeve 1161 is the same as the appearance structure of the atomizer 110, the atomizer 110 is arranged in the sleeve 1161, the atomization assembly 113 of the atomizer 110 stretches out of the sleeve 1161, the connector 1162 of the silicone sheath 116 is fixed to the top of the vehicle charger body 200, and in this way, the atomizer 110 and the vehicle charger body 200 are fixedly connected into a whole through the silicone sheath 116. The silicone sheath 116 not only has a connection function, but also has packaging and dust-preventing functions, and meanwhile, the silicone sheath 116 has a good hand feeling.

An S-shaped pipe (not shown in the FIGs) is arranged in the hollow connection part 1163 in a penetrating mode, and a wire (not shown in the FIGs) electrically connected with the controller 115 and the vehicle charger body 200 is arranged in the S-shaped pipe. In this way, the humidifier main body 100 of the anti-seepage vehicle-mounted humidifier is electrically connected with the vehicle body through the vehicle charger body 200. The humidifier main body 100 is fixed through the S-shaped pipe so that the humidifier main body 100 can be conveniently adjusted to any angle and any altitude to be fixed. One end of the S-shaped pipe is fixed in the shell 114 through a fixing component 500. Specifically, as is shown in FIG. 4 and FIG. 8, the fixing component 500 comprises a sleeve pipe 510 and a positioning block 520 arranged outside the sleeve pipe 510 in a sleeving mode, and a third clamping groove 1147 allowing the positioning block 520 to be clamped therein to be positioned is formed in the shell 114. One end of the S-shaped pipe stretches into the sleeve pipe 520, the sleeve pipe 520 is fixed in the shell 114 through the positioning block 520, and thus one end of the S-shaped pipe is fixed in the shell 114.

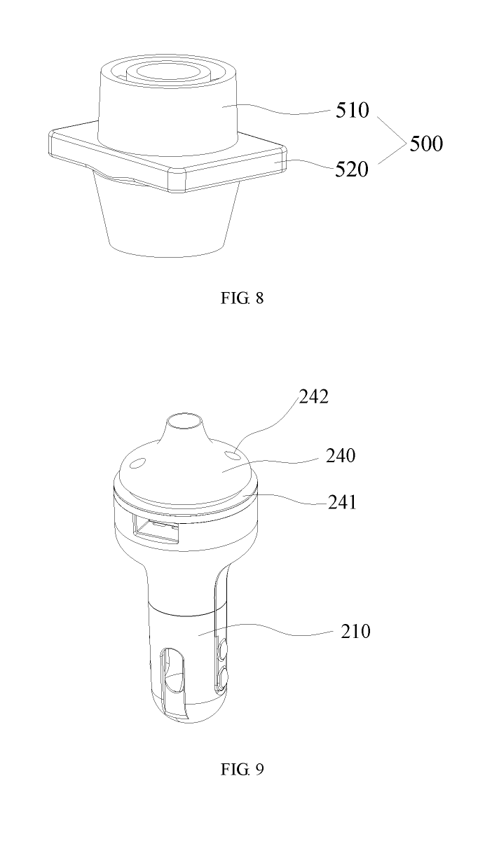

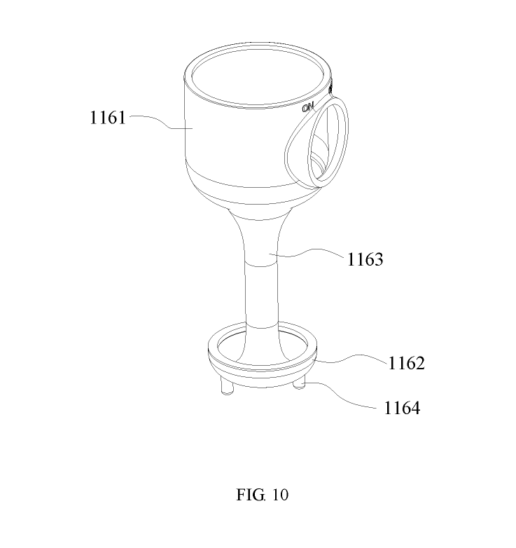

As is shown in FIG. 2, the vehicle charger body 200 comprises a vehicle charger body main shell 210, a vehicle charger circuit board 220, a contact piece 230 and an upper cover 240, wherein the vehicle charger body main shell 210 is provided with an accommodating cavity, the vehicle charger circuit board 220 is arranged in the vehicle charger body main shell 210, the contact piece 230 is electrically connected with the vehicle charger circuit board 220, and the upper cover 240 is arranged on the vehicle charger body main shell 210 in a covering mode. The contact piece 230 partially stretches out of the vehicle charger body 200 main shell and is connected with a vehicle-mounted circuit. As is shown in FIG. 2 and FIG. 9, the contact piece 230 comprises a first contact piece part 231 and a second contact piece part 232 which are of different structures. As is shown in FIG. 9 and FIG. 10, a fourth clamping groove 241 is formed in the upper cover 240, and the bottom edge of the connector 1162 of the silicone sheath 116 is clamped in the fourth clamping groove 241; meanwhile, two positioning columns downwards stretch out from the bottom of the connector 1162, and positioning holes 242 allowing the positioning columns 1164 to be stretch therein to be fixed are formed in the upper cover 240. Furthermore, for improving the appearance effect of the anti-seepage vehicle-mounted humidifier, annular decorations 400 are arranged between the water tank 120 and the atomizer 110, between the silicone sheath 116 and the vehicle charger body 200, and outside the atomization assembly 113.

The operating principle of the anti-seepage vehicle-mounted humidifier in the embodiment: when the humidifier is required to operate, the atomization piece cover 1132 exposed out of the silicone sheath 116 is rotated and then drives the pipe body 112 to rotate, the switch trigger 1126 on the pipe body 112 rotates along with the pipe body 112, the water inlet 1121 is right located at the communication port 1111 of the valve body 111 when the switch trigger 1126 rotates to the atomization switch 1152 and triggers the atomization switch 1152, at the moment, the water tank 120 is communicated with the pipe body 112, the atomization switch 1152 is turned on, the atomization piece 1131 operates, and the humidifier starts to operate for humidification; when humidification is not needed anymore, the atomization piece cover 1132 is rotated again, the switch trigger 1126 on the pipe body 112 is separated from the atomization switch 1152, the atomization switch 1152 is turned off, the atomization piece 1131 stops operating, at the moment, the water inlet 1121 deviates from the communication port 1111, and the water tank 120 is isolated from the pipe body 112 and the atomizer 110, so that residual water in the water tank 120 is prevented from entering the atomizer 110, water seepage is avoided accordingly, and the problem of water seepage of existing humidifiers is solved.

The above embodiment is only a preferred embodiment of the invention and is not used for limiting the invention, and any modifications, equivalent substitutes and improvements made based on the spirit and principle of the invention are all within the protection scope of the invention.

What is claimed is:

1. An anti-seepage vehicle-mounted humidifier, comprising a humidifier main body and a vehicle charger body, wherein the vehicle charger body is connected with the humidifier main body and can be connected with the vehicle body to achieve electrical connection between the humidifier main body and the vehicle body, and the humidifier main body comprises an atomizer and a water tank arranged above the atomizer; characterized in that the atomizer comprises a valve body, a pipe body, an atomization assembly and a controller, wherein the pipe body stretches into the valve body and can rotate in the valve body, the atomization assembly is arranged at the end of the pipe body and can rotate along with the pipe body, and the controller is used for controlling the atomization assembly; the valve body is provided with a communication port communicated with the water tank, and the pipe body is provided with a water inlet; when the water inlet rotates to the communication port along with the pipe body, the pipe body is communicated with the water tank, and the atomization assembly is started by the controller to enter into humidification mode; when the water inlet rotates along with the pipe body to deviate from the communication port, the pipe body is isolated from the water tank, and the atomization assembly is controlled by the controller to stop humidifying.

2. The anti-seepage vehicle-mounted humidifier according to claim 1, characterized in that the atomizer further comprises a shell, and the valve body and the pipe body are arranged in the shell; a mounting hole is formed in the side wall of the shell, the atomization assembly is arranged outside the mounting hole, and the water tank is arranged at the top of the shell.

3. The anti-seepage vehicle-mounted humidifier according to claim 2, characterized in that the top edge of the valve body extends outwards to form a round flange, and a first clamping groove allowing the round flange to be clamped therein is formed in the shell.

4. The anti-seepage vehicle-mounted humidifier according to claim 1, characterized in that the valve body comprises an upper cylindrical pipe which is arranged longitudinally and a lower cylindrical pipe which is arranged transversely and communicated with the upper cylindrical pipe, a connecting pipe which can stretch into the upper cylindrical pipe and is connected with the upper cylindrical pipe in a threaded mode is arranged at the bottom of the water tank, and the pipe body is arranged in the lower cylindrical pipe.

5. The anti-seepage vehicle-mounted humidifier according to claim 1, characterized in that the atomization assembly comprises an atomization piece and an atomization piece cover; a cavity is formed in the end of the pipe body, and the atomization piece is arranged in the cavity; a second clamping groove is formed in the end of the pipe body, the atomization piece cover is located outside the atomization piece, and a clamping block which can be clamped in the second clamping groove is arranged on the atomization piece.

6. The anti-seepage vehicle-mounted humidifier according to claim 1, characterized in that the controller comprises a mainboard and an atomization switch arranged on the mainboard; the pipe body comprises a first pipe body part and a second pipe body part, the first pipe body part stretches into the valve body, the water inlet is located in the first water pipe body part, and a switch trigger which can trigger the atomization switch is arranged on the second pipe body part.

7. The anti-seepage vehicle-mounted humidifier according to claim 2, characterized by further comprising a silicone sheath, wherein the silicone sheath comprises a sleeve located at the top, a connector located at the bottom and a connection part through which the sleeve and the connector are communicated, the atomizer is arranged in the sleeve, and the connector is fixed to the top of the vehicle charger body.

8. The anti-seepage vehicle-mounted humidifier according to claim 7, characterized in that an S-shaped pipe is arranged in the connection part in a penetrating mode, a wire electrically connected with the controller and the vehicle charger body is arranged in the S-shaped pipe, and the top end of the S-shaped pipe is fixed in the shell through a fixing component; the fixing component comprises a sleeve pipe and a positioning block arranged outside the sleeve pipe in a sleeving mode, and a third clamping groove allowing the positioning block to be clamped therein to be positioned is formed in the shell.

9. The anti-seepage vehicle-mounted humidifier according to claim 7, characterized in that a fourth clamping groove is formed in the top of the vehicle charger body, and the bottom edge of the connector is clamped in the fourth clamping groove; positioning columns downwards stretch out from the bottom of the connector, and positioning holes allowing the positioning columns to stretch therein to be fixed are formed in the top of the vehicle charger body.

10. The anti-seepage vehicle-mounted humidifier according to claim 1, characterized in that the vehicle charger body comprises a vehicle charger body main shell, a vehicle charger circuit board, a contact piece and an upper cover, wherein the vehicle charger body main shell is provided with an accommodating cavity, the vehicle charger circuit board arranged in the vehicle charger body main shell, the contact piece is electrically connected with the vehicle charger circuit board, partially stretches out of the vehicle charger body main shell and is connected with a vehicle-mounted circuit, and the upper cover is arranged on the vehicle charger body main shell in a covering mode.
